(19) United States
(12) Patent Application Publication
(10) Pub. No.: US 2004/0246673 A1
(43) Pub. Date: Dec. 9, 2004

(54) Removable mounting structure for installing and accessing a computer drive in a computer

(76) Inventor: Yi-Lung Kuo, Keelung (TW)

Correspondence Address: FENWICK & WEST LLP, SILICON VALLEY CENTER, 801 CALIFORNIA STREET, MOUNTAIN VIEW, CA, 94041, US

(21) Appl. No.: 10/806,945

(22) Filed: Mar. 22, 2004

Related U.S. Application Data
(60) Provisional application No. 60/456,643, filed on Mar. 20, 2003.

(51) Int. Cl. G06F 1/16

(52) U.S. Cl. 361/685

(57) ABSTRACT

Installation and servicing of a computer drive from outside the confines of a computer can be accomplished through use of a removable mounting structure on which one or more drives can be attached. After a drive is fixed to the structure, the assembly can be installed in a computer. Once installed, the assembly can be removed to access or replace the drive. The invention can be used to install and access drives, including floppy drives, hard disk drives, and CD-DVD drives, and a single structure may be able to accommodate drives of different sizes. The invention may be implemented in a small form factor computer or other PC.

### CROSS REFERENCE TO RELATED APPLICATIONS

This application claims the benefit of U.S. Provisional Application Ser. No. 60/456,643, filed Mar. 20, 2003, which is hereby incorporated in its entirety by reference.

### BACKGROUND

1. Field of the Invention

This invention relates generally to installing and accessing a drive within a computer using a removable mounting structure.

2. Background of the Invention

Personal computers (PCs) are generally equipped with floppy, hard disk, and CD-DVD drives. Although there are many different types of PC chassis available on the market, typically the floppy and hard disk drives must be attached to the chassis within a limited installation space. After the floppy and hard disk drives are installed, a CD-DVD drive may be installed by sliding and fixing the CD-DVD drive into its own separate bay. Because space within the chassis is limited, the installation process can be time-comsuming and is not well-suited for mass production. Furthermore, the resulting configuration makes subsequent access to the floppy and hard disk drives difficult, thus complicating the servicing of the drives.

Thus, it is desirable to devise a system that avoids the space constraints of present methods for installing computer drives within PCs and affords easy access to drives after their initial installation.

### SUMMARY OF THE INVENTION

Accordingly, the invention provides systems and methods for installing a drive in a computer that avoids the space limitations inherent in present methods of installation and their resulting configurations. Specifically, the invention uses a removable structure to which a computer drive or drives can be mounted outside of a computer. After the drive or drives are mounted to the structure, the assembly can be installed within the computer. The assembly can later be removed, thereby enabling access to the drives from outside the confines of the computer.

In one embodiment of the invention, there is a removable mounting structure for receiving a computer drive. The structure is adapted to be mounted to a chassis for a small form factor computer, and included in the system is an attachment mechanism for detachably coupling the mounting structure to the computer chassis

In one embodiment of the invention, a user secures a computer drive to a mounting structure, which comprises a base panel, two side panels, and a flange bordering each side panel. The connection between each side panel and its corresponding flange is generally parallel to the connection between the side panel and the base panel. The mounting structure and computer drive can be placed in a computer fitted to receive the mounting structure and thus be secured to the computer.

### BRIEF DESCRIPTION OF THE DRAWINGS

FIGS. 1(a) and 1(b) are front and top views, respectively, of a mounting structure for installing and accessing a computer drive in accordance with one embodiment of the invention.

FIGS. 2(a) and 2(b) are front and side views, respectively, of a mounting structure for installing and accessing a computer drive on which floppy and hard disk drives have been mounted in accordance with one embodiment of the invention.

FIG. 3 is a top view of a computer bay for receiving a mounting structure in accordance with one embodiment of the invention.

FIG. 4 is a front view of a small form factor computer that contains computer drives mounted on a mounting structure for installing and accessing a computer drive, and the assembly installed in the computer, in accordance with one embodiment of the invention.

FIG. 5 is a side view of drives installed in a computer in accordance with an embodiment of the invention.

### DETAILED DESCRIPTION OF THE PREFERRED EMBODIMENTS

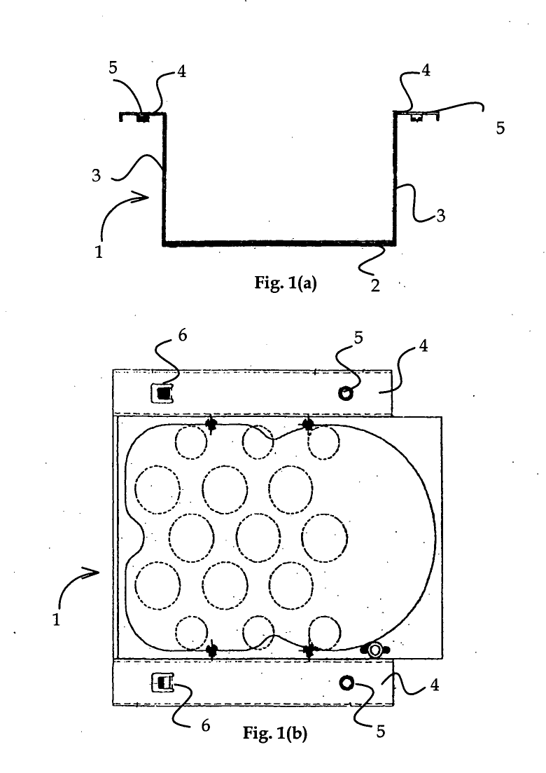

FIG. 1(a) depicts the front view of a removable mounting structure 1 for installing or accessing a computer drive in accordance with an embodiment of the invention. As shown in FIG. 1(a), the mounting structure 1 comprises a base panel 2, two side panels 3, and flanges 4 bordering each side panel 3, the connecting edge between each side panel 3 and base panel 2 parallel to the connecting edge between each side panel 3 and corresponding flange 4. FIG. 1(b) shows a top view of the mounting structure 1 of FIG. 1(a). In the mounting structure of FIGS. 1(a) and 1(b), each flange contains a hole for a screw 5 in addition to a tab 6 by which the mounting structure 1 can be attached to a computer (not shown). The structure shown may alternatively be described as a “mounting structure,” “frame,” “bay,” “tray,” or any of a host of other descriptive names.

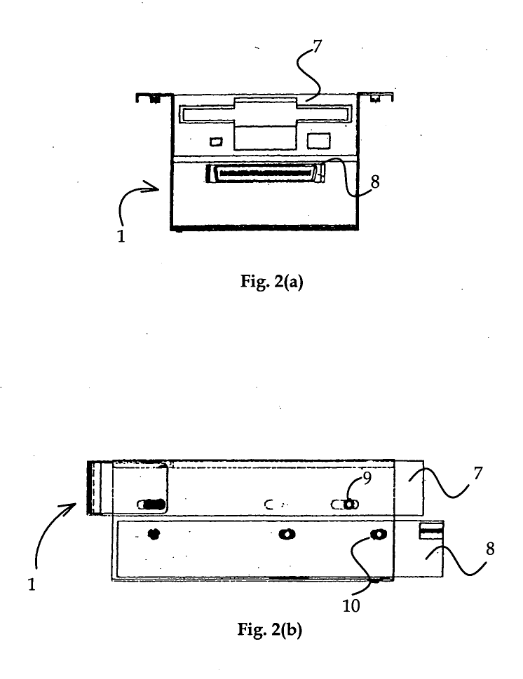

A computer drive may be installed in the mounting structure. FIGS. 2(a) and 2(b) depict front and side views, respectively, of a mounting structure 1 with a floppy drive 7 and a hard disk drive 8 installed. As shown in FIGS. 2(a) and 2(b), the mounting structure supports a floppy drive 7 stacked on top of a hard drive 8. Alternatively, the hard drive 8 could be stacked on top of the floppy drive 7, or only one drive could be mounted in the mounting structure 1. In addition, other components configured to fit on the mounting structure 1 such as a smart card reader (not shown) may be mounted on the mounting structure 1. As shown in FIG. 2(b), the floppy drive 7 and hard drive 8 can be secured to the mounting structure 1 with fastening components, herein depicted as screw holes 9 and 10; however, other types of fastening components and other methods of securing the drives to the mounting structure may be used. As illustrated in FIGS. 1(a), 1(b), 2(a), and 2(b), the invention can be used to install, access, or replace the drives mounted in it from outside a computer (not shown). The mounting structure 1 can be detachably secured to a computer. As shown in FIG. 1(b), in an embodiment, two screw holes 5 and two tabs 6 are located on the flanges 4 of the mounting structure 1.

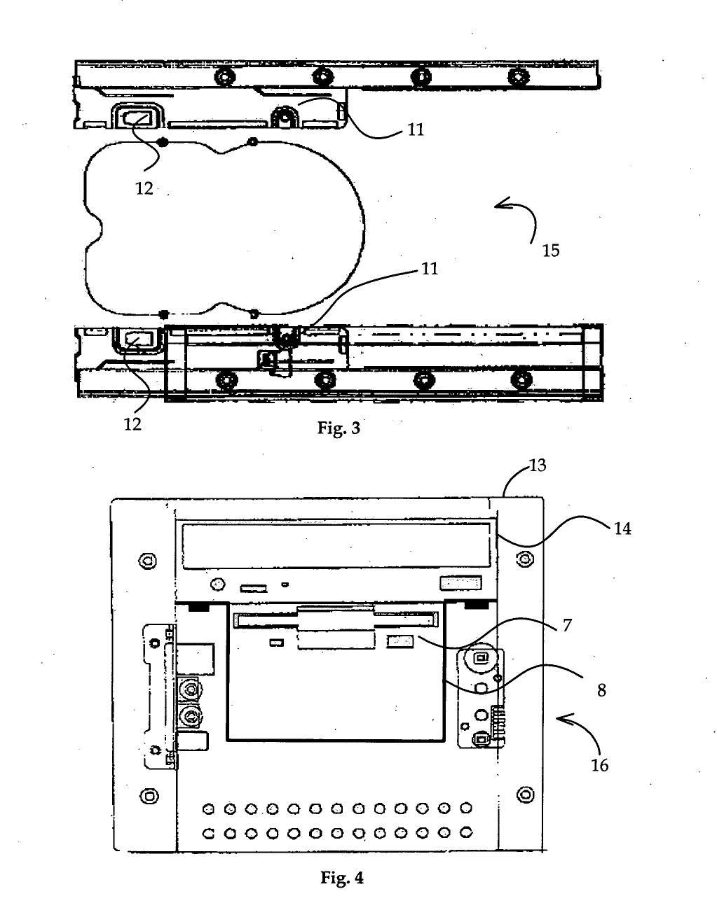

FIG. 3 is a top view of a computer bay for receiving a mounting structure in accordance with one embodiment of the invention. As shown in FIG. 3, drive bay of a computer 15 contains hollow tabs 12 and screw holes 11. A mounting structure 1 may be secured directly to the drive bay, when tabs 6 on the mounting structure 1 are inserted in the hollow tabs 12 on the drive bay and screws are used to connect the holes 5 in the mounting structure 1 to the holes 11 in the drive bay. The mounting structure may be attached to various parts of the computer other than the drive bay. In addition, mechanisms other than the tab and screw depicted in FIGS. 1(a) and 3 could also be used, in combination or alone, to attach the mounting structure to a computer.

FIG. 4 shows a front view of an embodiment of the invention as implemented within a small form factor computer 16. A floppy drive 7 and CD-DVD drive 14 are mounted to a mounting structure 1, which is removably secured to the computer. In one embodiment of the invention, the top of the computer 13 is opened to enable installation of the CD-DVD drive 14 on the mounting structure 1. As FIG. 4 illustrates, the mounting structure can support drives of different sizes, in this case a 3½-inch floppy drive and a 5¼-inch CD-DVD drive, although other sizes are also possible.

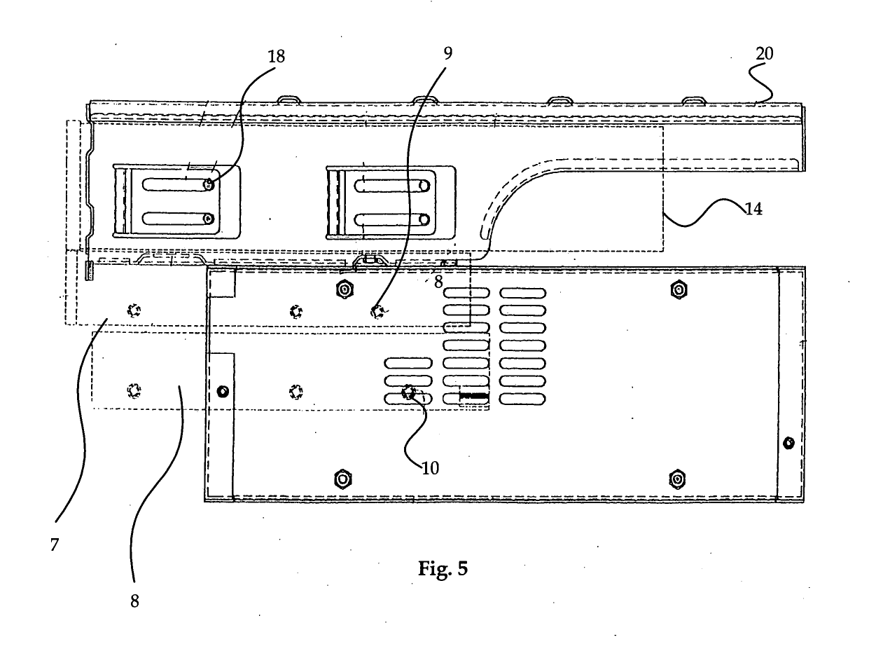

FIG. 5 shows a side view of drives installed in a computer in accordance with an embodiment of the invention. A mounting structure (not shown) holds two 3½-inch drives 7 and 8, one of which is an internal hard drive 8 and the other 7 which is a floppy drive or a card reader adapted to be accessed from outside the computer. A third 5¼-inch drive 14 can be fixed to drive bay structure 20 through screws in screw holes 18. The 3½-inch drives 7 and 8 can be installed to the mounting structure (not shown) by screws in screw holes 9 and 10, and then mounted to the chassis below drive bay structure 20.

Now taking an example to explain the operation of an embodiment of the invention, a computer drive may be secured to a mounting structure 1. The mounting structure 1 comprises a base panel 2, two side panels 3, and flanges 4 bordering each side panel 3, the connecting edge between each side panel 3 and base panel 2 parallel to the connecting edge between each side panel 3 and corresponding flange 4. A drive can be attached to the mounting structure 1 by way of a screw or other fastening mechanism. This step can take place outside of the computer, enabling access to the drive from outside the confines of the computer chassis. The mounting structure 1 containing the computer drive is then placed within a computer fitted to receive the mounting structure 1.

The mounting structure 1 with drive mounted on it placed within the computer is then secured to the computer chassis. In an embodiment, the securing of a mounting structure 1 to a computer chassis is achieved by matching the screw holes 5 and tabs 6 on the flanges 4 of the mounting structure 1 to the screw holes 11 and spaces for tabs 12 on a drive bay 15 within a computer. The mounting structure can be secured to a computer chassis, however, in alternative ways. In this way, a computer drive can be installed in a computer without any space limitations. In an embodiment, subsequently, a second drive may be secured to the computer, through various means. In an embodiment, the mounting structure may also be accessed through an opening in the computer that may be closed after access.

In another embodiment, a mounting structure 1 can be used to facilitate access to a computer drive after it has already been installed in a computer. A mounting structure 1 with a drive mounted on it is removed from within a computer. From outside the computer, the drive is accessed, for example for the purposes of servicing, replacing, or changing the drive. This step can take place either while the drive is still mounted on the mounting structure 1 or after it has been removed from the mounting structure 1. If the original drive is removed, it may be re-attached to the mounting structure, or replaced with a new drive or drives or component or components fitted to be mounted on the mounting structure. After access has been completed, the mounting structure 1 is re-attached to the computer. In an embodiment, subsequently, a second drive may be secured to the computer, through various means. In an embodiment, the mounting structure 1 may also be accessed through an opening in the computer that may be closed after access.

The foregoing description of the embodiments of the invention has been presented for the purpose of illustration; it is not intended to be exhaustive or to limit the invention to the precise forms disclosed. The figures are not drawn to scale. Persons skilled in the relevant art can appreciate that many modifications and variations are possible in light of the above teachings. It is therefore intended that the scope of the invention be limited not by this detailed description, but rather by the claims appended hereto.

I claim:

1. A system for facilitating installation of and access to a computer drive within a small form factor computer, the system comprising:
a chassis for a small form factor computer;
a removable mounting structure for receiving at least one electronic storage device, the mounting structure adapted to be mounted within the computer chassis; and
an attachment mechanism for detachably coupling the mounting structure to the computer chassis.

2. The system of claim 1, wherein the mounting structure is capable of receiving a floppy drive and a hard disk drive interchangeably stacked on each other.

3. The system of claim 1, wherein the mounting structure is designed to receive at least two disk drives of different sizes.

4. The system of claim 1, wherein the mounting structure comprises a base panel, two side panels, and a flange bordering each side panel, wherein the connection between each side panel and its corresponding flange is substantially parallel to the connection between the side panel and the base panel.

5. The system of claim 1, wherein the attachment mechanism comprises a tab and a hollow space fitted to receive the tab.

6. The system of claim 5, wherein the hollow space is located on the mounting structure.

7. A system for facilitating installation of and access to a computer drive, the system comprising:
a mounting structure comprising a base panel, two side panels, and a flange bordering each side panel, wherein the connection between each side panel and its corresponding flange is substantially parallel to the connection between the side panel and the base panel, each side panel containing a hole for a screw, and each flange containing a hole for a screw and a downward tab, the mounting structure capable of receiving a floppy drive and a hard drive interchangeably stacked upon each other such that the drives rest on the base panel; and
a drive bay within a computer capable of receiving the mounting structure, containing at least two screw holes and two hollow tabs that match the screw holes and downward tabs on the flanges of the mounting structure by which the mounting structure can be attached to the drive bay, the drive bay further capable of supporting a CD-ROM drive stackable on the mounting structure.

8. A method of installing a computer drive in a computer, the method comprising:
securing a computer drive to a mounting structure comprising a base panel, two side panels, and a flange bordering each side panel, wherein the connection between each side panel and its corresponding flange is substantially parallel to the connection between the side panel and the base panel;
placing the mounting structure and computer drive in a computer fitted to receive the mounting structure; and
securing the mounting structure to the computer.

9. The method of claim 8, further comprising:
after securing the mounting structure to the computer, removably coupling a second drive to the computer.

10. The method of claim 8 further comprising:
after securing the mounting structure to the computer, accessing the mounting structure through an opening in the computer; and
after accessing the mounting structure, closing the opening.

11. The method of claim 8, wherein the mounting structure is designed to receive at least two drives of different sizes.

12. A method of accessing a computer drive from outside a computer, the method comprising:
removing from a computer a mounting structure for receiving a computer having a computer drive mounted thereon;
accessing the drive from outside the computer; and
re-attaching the mounting structure to the computer.

13. The method of claim 12, wherein the mounting structure comprises a base panel, two side panels, and a flange bordering each side panel, wherein the connection between each side panel and its corresponding flange is substantially parallel to the connection between the side panel and the base panel.

14. The method of claim 12, further comprising:
after re-attaching the mounting structure to the computer, removably coupling a second drive to the computer.

15. The method of claim 12, further comprising:
after re-attaching the mounting structure to the computer, accessing the mounting structure through an opening in the computer; and
after accessing the mounting structure, closing the opening in the computer.
